(19) United States
(12) Patent Application Publication
(10) Pub. No.: US 2008/0317248 A1
(43) Pub. Date: Dec. 25, 2008

(54) INFORMATION EXCHANGE DEVICE

(76) Inventors: Norihiko Naono, Tokyo (JP); Tomohisa Ota, Tokyo (JP)

Correspondence Address: WINSTON & STRAWN LLP;PATENT DEPARTMENT, 1700 K STREET, N.W., WASHINGTON, DC, 20006, US

(21) Appl. No.: 12/143,574

(22) Filed: Jun. 20, 2008

(30) Foreign Application Priority Data
Jun. 25, 2007 (JP) P2007-165789

(51) Int. Cl. H04L 9/00

(52) U.S. Cl. 380/255

(57) ABSTRACT

An embodiment of the present invention provides an information exchange device. The information exchange device includes a storage device which stores information items for disclosure, an encryption device which encrypts each of the information items for disclosure using a plurality of prepared secret keys which correspond to each of the information items for disclosure, a transmitting device which transmits the encrypted information items and the plurality of prepared secret keys, and a decryption device which receives an encrypted information item which is arbitrarily selected from the plurality of encrypted information items, receives a secret key related to the selected encrypted information item from among the plurality of prepared secret keys, and decrypts the selected encrypted information item using the secret key.

### CROSS REFERENCE TO RELATED APPLICATION

This application is based upon and claims the benefit of priority from the prior Japanese Patent Application No. 2007-165789, filed on Jun. 25, 2007; the entire contents of which are incorporated herein by reference.

### BACKGROUND OF THE INVENTION

1. Field of the Invention

The present invention concerns an information exchange device and a method for operating an information exchange device for exchanging information among information terminals.

2. Description of the Related Art

In recent years, the information and communication terminals such as personal computers, PDAs (Personal Digital Assistances), and cellular phones, which are capable to connect to the Internet are becoming popular. Network connectivity of consumer devices such as digital cameras, video cameras, portable music players, game machines, portable game machines, and video recorders is increasing. Various services are created and usability is improved by connecting a variety of information terminals to the Internet.

Amongst these various services, the service for information disclosure based on the Web service is the most prominent in the information communication area. Due to the popularity of the Web, not only is information transmission possible but valued contents such as pictures or music can also be transmitted through the Web. Usage of the Web is expanding rapidly also because of reasons such as its ability to offer financial transactions.

On the other hand, due to networking of a variety of information terminals, the risk of leakage of private information on the network without permission of the information owner is increasing. This problem is becoming a major social issue along with the growing interest and the legislative movement on personal information protection.

Web-based information disclosing technology is considered as the basis for disclosing information to the entire world. Almost all the information on Web sites around the world can be accessed by anybody. When it is necessary to restrict user access to the information, a method to restrict access to the information on Web sites through authentication methods such as user name, password etc. depending on the accessed information is used. However, flexibility of information disclosure is lost from the viewpoint of controlling “Which information is to be disclosed and to whom”, and considerable effort and money is required for management operations. Therefore, general internet users find the operations difficult and in most cases, it is not even safe. Actually, the information that should be preserved exists in the form of a file on the Web server. Hence, leakage of information often occurs using various technical and artificial methods.

One more problem due to networking of a variety of information terminals is that the maintenance and management of information by the user is becoming more and more difficult as a result of rapidly increasing information volume that is exchanged through the network. As a result of exponential growth in the volume of information that is managed and disclosed by other users on the Internet and the volume of personal information managed on various information terminals, it is difficult to use the required information at the right time.

Regarding the information that is managed and disclosed by others on the Internet, various techniques to search the necessary information on the Internet efficiently from various information terminals are proposed. A user can share a variety of information without suffering a loss of convenience. Presently, the search technique holds top position in information communication technology.

On the other hand, acquisition, disclosure of personal information by exchanging via e-mail and information synchronization methods on various terminals connected to the Internet is common for exchanging personal information (such as various personal information, personal mails, photographs, videos etc.) managed by the users themselves as is disclosed by U.S. Pat. No. 6,665,837, for example. However, in these methods, when acquiring the information, there are problems such as there is no guarantee that updated information is always sent from other users and there is lack of certainty in acquiring information. Moreover, when it is necessary to input the information received through e-mail into a users own database, there is a problem of managing the information acquired.

In U.S. Pat. No. 7,080,104, synchronization and disclosure of personal information on a web server is proposed as the means to solve these problems. As an extension of this technology, a service called a social network service (SNS for short) with which personal information on a server is able to be exchanged between limited users, has recently become popular as disclosed in U.S. Pat. No. 7,069,308. In the service of an SNS, a provider establish a server and issues invitations for new members, uploads the personal information of each member on the server after registering names and passwords of users and securing an authentication method of a shared folder. According to this service, the latest consistent information can be browsed including other users information since the provider's database is updated automatically when information of another user is updated. Moreover, information can be disclosed only to acquaintances. Only limited information such as a diary and photographs can be disclosed only to the acquaintances. However, there is a problem of delayed and unstable operations due to the access to remote data on a web server. There is a problem of high risk for the provider, who manages all the information accumulated in the server. Moreover, there is a problem that highly-confidential information cannot be stored because weak authentication methods such as user name and password are generally used in several SNS services.

Moreover, in the services for the disclosure and synchronization of personal information on a web server such as SNS, it is necessary for the service provider to raise the funds required for maintenance and management of the server. These funds are financed through advertisements etc. published on common Web sites. Therefore, it is necessary to increase the number of members in such services. It is difficult to charge service fees on the users even in the case of a service for exchanging this type of personal information since all the general or public web sites are free of charge. Due to this, the quality and the confidentiality of service of synchronization and disclosure of personal information through this type of server does not improve.

### BRIEF SUMMARY OF THE INVENTION

There are at least six specific problems in the currently-proposed e-mail or web-based methods related to acquisition and disclosure of disclosure target information on various information terminals. Examples of disclosed information can be an attribute information such as telephone number, address, e-mail address etc. of an individual, information such as a photo, a video, a diary, a schedule, a medical history, a work experience, the current location, the public key, the secret key etc. possessed by an individual, information such as organization and corporate telephone number, e-mail address, personal information of a member of an organization or corporation, or information related to an organization or corporation such as organizational information, financial information, customer information etc. possessed by an organization or a corporation.

First, there is lack of information consistency between terminals. Second, it is difficult to manage the information disclosed by others. Third, it is difficult to manage information disclosed by users themselves. Fourth, there is lack of flexibility in disclosed information. Fifth, it is difficult to control the information after disclosure. And lastly, sixth, it is economically difficult to maintain a disclosure management service of disclosed information through the web. It is difficult to solve these economically rational problems in previously proposed methods such as information exchange through e-mail or disclosure and synchronization of information through a web server. Moreover, it aims at searching the necessary information from the information disclosed on the Internet, and it is the problem that cannot be solved by improving the precision of existing search techniques.

The first problem is the lack of uniformity in the information between the terminals. Here, suppose information on a specific terminal is duplicated and stored in another terminal connected to a network. Even though the information stored in the above-mentioned specific terminal is updated, the information stored in the other terminal is not updated unless an explicit operation is executed. For example, after a user A sends his telephone number from its terminal to another user B's terminal, if the telephone number of the user A is later updated, the telephone number of the user A stored in the user B's terminal is not updated unless an explicit operation such as sending an e-mail to user B's terminal is executed by the user A. This problem also occurs when the user A is using multiple terminals. For example, even though the user A, who is using three terminals: a desktop PC, a portable PC and p cellular phone, updates the phone book on the portable PC, the phone book on other terminals is not updated unless the user A gives an input to the desktop PC or the cellular phone, or executes an operation explicitly for information synchronization. When the information to be managed or the number of partners or terminals sending its duplicate information increases, the user cannot manage an update status of each terminal and hence, consistency of information between terminals is not maintained.

The second problem is the difficulty in managing the information of another user. For example, the disclosure target information of another user that is received mainly through e-mail cannot be managed. Suppose that a telephone number of another user is updated. Information received by e-mail is generally managed by entering it in a personal address book. However, if the amount of information is too large, considerable effort is required to keep this address book updated. Therefore, many users cannot manage their address book appropriately.

The third problem for a user is the difficulty in managing their own disclosure information. Here, when their own disclosure target information is updated, it has to be explicitly notified to their acquaintances by e-mail. For example, when a user's own telephone number or company name has changed, new information can be notified to their acquaintances by e-mail, etc. However, when there are too many acquaintances or too much information, the acquaintances may not always receive the required information and it becomes difficult for the owner of disclosure target information to understand to whom the information has been notified.

The fourth problem is a lack of flexibility of information disclosure where it is difficult to disclose the specific disclosure target information to a specific partner according to the intention of the information owner. If target information is disclosed through the Web, it is possible to avoid the trouble in information disclosure management by using the e-mail as mentioned above. However, basically all information is disclosed all over the world through the Web. For example, disclosure control broadly classified as “disclose the dairy to a friend” is possible by using the methods such as the SNS mentioned above. In information disclosure by e-mail, although disclosure management flexibility can be maintained, disclosure management is complicated as mentioned above. In other words, the above mentioned third and fourth problems are contradictory and there is no appropriate method to resolve these problems.

The fifth problem is the difficulty of information control after disclosure. In the present communication method, since ownership rights of disclosure target information are transferred to ‘disclosed to’ once the information is disclosed, information cannot be controlled by the information owner. For example, disclosure target information sent through e-mail and entered in a web site is processed as the information belonging to the ‘disclosed to’ and it can be used and re-disclosed at the desired ‘disclosed to.’ This information cannot be controlled by the primary owner of disclosure target information.

The sixth problem is that it is difficult to maintain the disclosure management services of disclosure target information where the Web is used from an economical point of view. This is because, in the present Internet environment, nearly all the software and search techniques are available free of charge and enhancement of user-friendliness in the software and services other than e-mail already used by the user are not considered. This is the reason why the SNS services are not more popular than the Web and E-mail, and there is no improvement in quality. In order to resolve this problem, it is essential for the service provider to develop a business model such that enough consideration can be obtained with respect to the disclosure management service of personal information. However, as of yet it has not been successfully developed.

An embodiment of the present invention provides an information exchange device comprising: a storage device which stores a information items for disclosure related to a user who discloses the information items; an encryption device which generates encrypted information items by encrypting each of the information items for disclosure using a plurality of prepared secret keys which correspond to each of the information items for disclosure; a transmitting device which transmits the plurality of encrypted information items and the plurality of prepared secret keys; and a decryption device which receives an encrypted information item which is arbitrarily selected from the encrypted information items, receives a secret key related to the selected encrypted information item from among the plurality of prepared secret keys, and decrypts the selected encrypted information item using the secret key.

An embodiment of the present invention provides an information exchange device comprising: a storage device which stores a information items for disclosure related to a user who discloses the information items for disclosure and also stores flag information of each of the information items for disclosure, the information items for disclosure and the flag information being correlated and stored in the storage device; an encryption device which generates encrypted information items by encrypting each of the information items for disclosure using a plurality of prepared secret keys which correspond to each of the information items for disclosure and the encrypted information items and the flag information of information for disclosure corresponding to the encrypted information items being correlated and stored in the storage device; and a transmitting device which transmits the encrypted information items with each of the encrypted information items correlated with the flag information.

An embodiment of the present invention provides an operation method of an information exchange device comprising: reading information items for disclosure related to a user who discloses the information for disclosure which is stored in a storage device; generating encrypted information items by encrypting each of the information items for disclosure using a plurality of prepared secret keys which correspond to each of the information items for disclosure; transmitting the encrypted information items and the plurality of prepared secret keys; and receiving an encrypted information item which is arbitrarily selected from the encrypted information items and receiving a prepared secret key related to the selected encrypted information item from among the plurality of prepared secret keys and decrypting the selected encrypted information item using the secret key.

### BRIEF DESCRIPTION OF THE DRAWINGS

FIG. 1 is an explanatory drawing of an information disclosure system comprising an information distribution server and a disclosure control server of an embodiment of the present invention.

FIG. 2 shows a block diagram of the information distribution server of an embodiment of the present invention.

FIG. 3(a) shows a block diagram of an information terminal of an embodiment of the present invention.

FIG. 3(b) shows a block diagram of an information terminal of an embodiment of the present invention.

FIG. 4(a) is a flowchart of a processing executed in an information terminal of an embodiment of the present invention.

FIG. 4(b) is a flowchart of a processing executed in the information terminals and the servers of an embodiment of the present invention.

FIG. 4(c) is a flowchart of a processing executed in the information terminals of an embodiment of the present invention.

FIG. 5(a) is an example of a window for information disclosure shown on an information terminal of an embodiment of the present invention.

FIG. 5(b) is an example of a window for information disclosure shown on an information terminal of an embodiment of the present invention.

FIG. 6(a) is an example of a window for controlling information disclosure between a plurality of terminals of an embodiment of the present invention.

FIG. 6(b) is an example of a window for controlling information disclosure between a plurality of terminals of an embodiment of the present invention.

FIG. 7 is an example of a window for controlling information disclosure between a plurality of terminals of an embodiment of the present invention.

FIG. 8 shows an example of a status of a memory unit of the information distribution server wherein a plurality of information terminals are disclosing information each other in an embodiment of the present invention.

### DETAILED DESCRIPTION OF THE PREFERRED EMBODIMENTS

The embodiments of the present invention are described below with reference to the drawings. Since the scope of this invention is defined clearly in the scope of the claims of the present invention, the description of the embodiments of the present invention does not have a restricted meaning and it simply aims at illustrating the general principles of the invention.

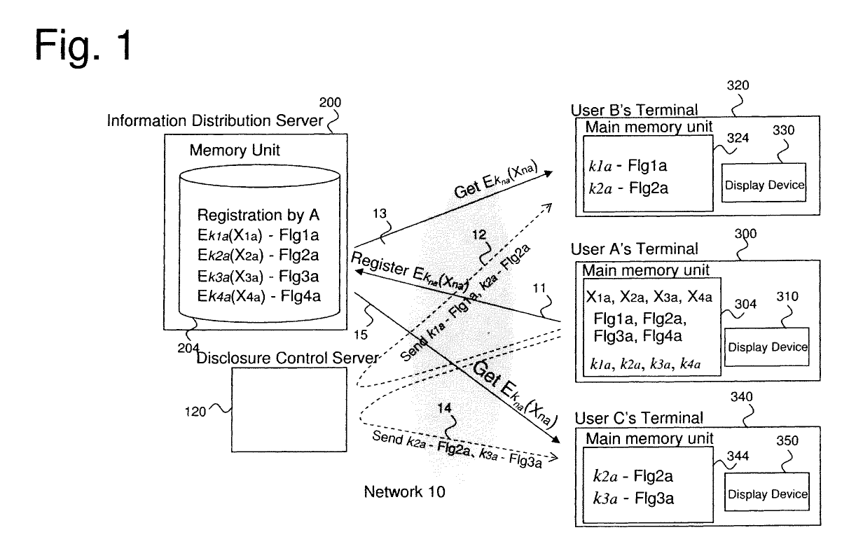

FIG. 1 shows an overall view of an information exchange system related to an embodiment of the present invention. The information exchange system comprises an information distribution server 200, a terminal 300 of a user A who discloses the disclosed information, a terminal 320 of a user B who is the recipient of the disclosed information, a terminal 340 of a user C, a disclosure control server 120, and a network 10 to which these terminals and servers are connected. Hereinafter, a user who disclosed information, such as the user A mentioned above, is sometimes called a discloser.

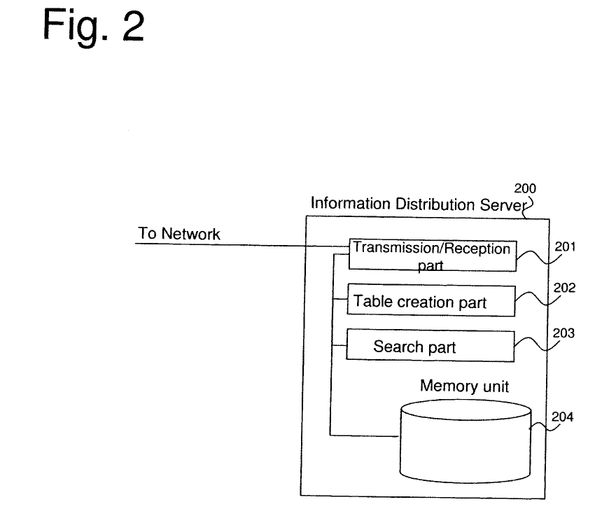

FIG. 2 shows an example of components of the information distribution server 200. Information distribution server 200 comprises a table creation part 202, a search part 203, and a memory unit 204. However, in the present invention, the structure of the information distribution server is not limited to that shown in FIG. 2, but any other structure where the methods of this invention can be executed can also be used. Further, each component shown in FIG. 2 can be implemented by an operating system, a middleware, or an application software which runs on the hardware of the server.

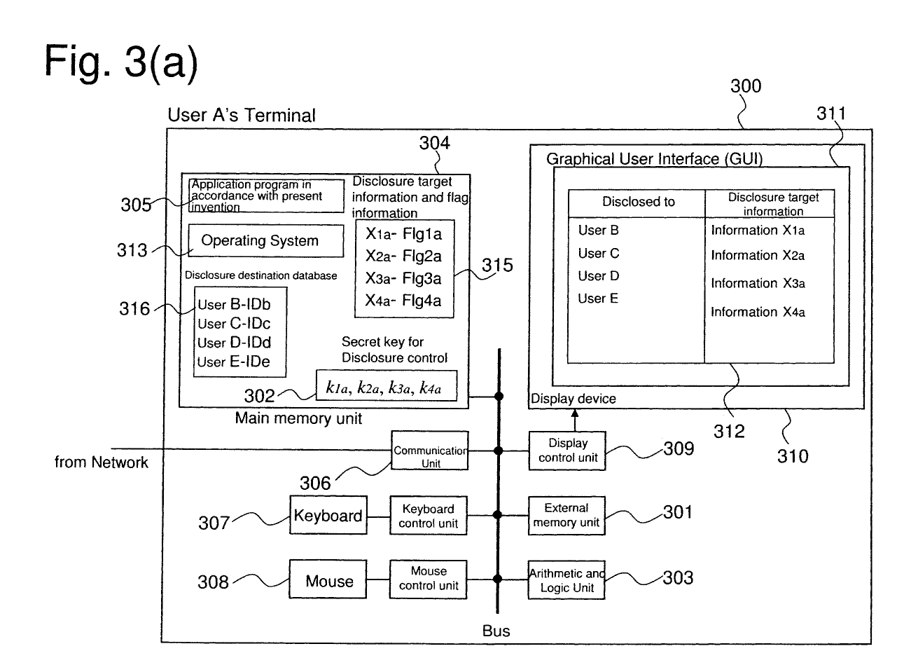

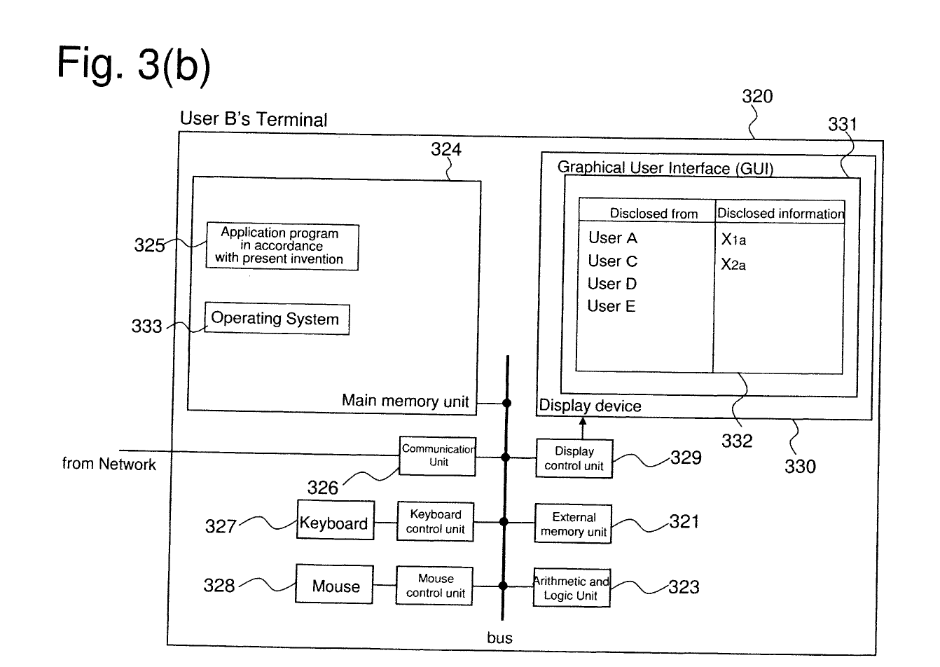

FIG. 3(a) shows the components of the user A's terminal 300. The user A's terminal 300 comprises an external memory unit 301, a calculation device (arithmetic and logic unit) 303, a main memory unit 304, a communication unit 306, an input device (a keyboard, for example) 307, an input device (a mouse, for example) 308, a display control unit 309, a display unit 310, etc. The main memory unit 304 stores an operating system 313 of the user A's terminal and an application program 305 of an embodiment of the present invention. However, in the present invention, the structure of user A's terminal shown in FIG. 3(a) only need not be used, but any other structure where the methods of this invention can be executed can also be used.

FIG. 3(b) shows the components of the user B's terminal 320. The user B's terminal 320 comprises an external memory unit 321, a calculation device (arithmetic and logic unit) 323, a main memory unit 324, a communication unit 326, an input device (a keyboard, for example) 327, an input device (a mouse, for example) 328, a display control unit 329, a display unit 330, etc. The main memory unit 324 stores an operating system 333 of user B's terminal and an application program 325 of an embodiment of the present invention. However, in the present invention, the structure of user B's terminal shown in FIG. 3(b) only need not be used, but any other structure where the methods of this invention can be executed can also be used.

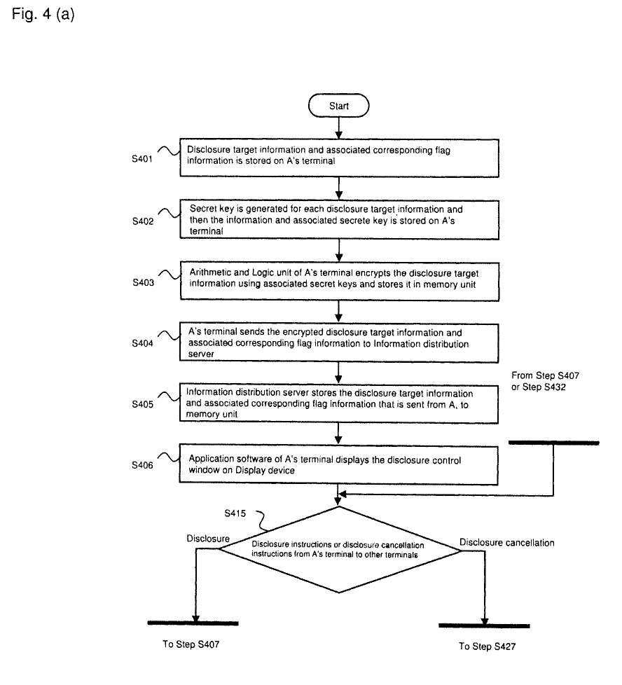

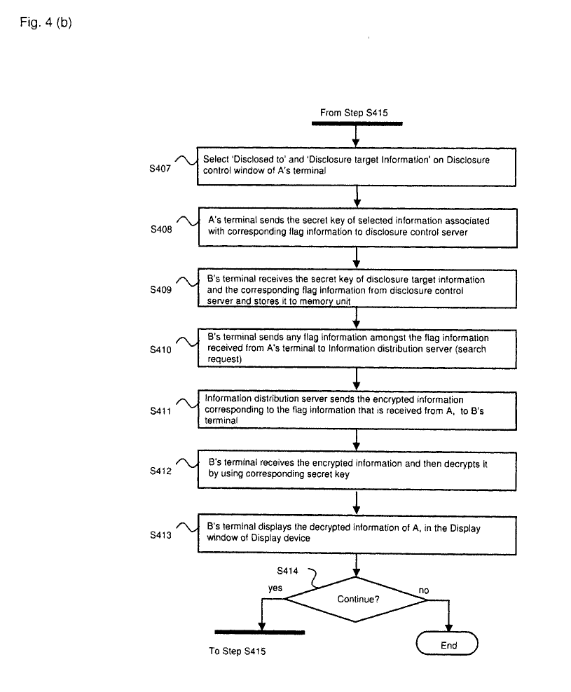

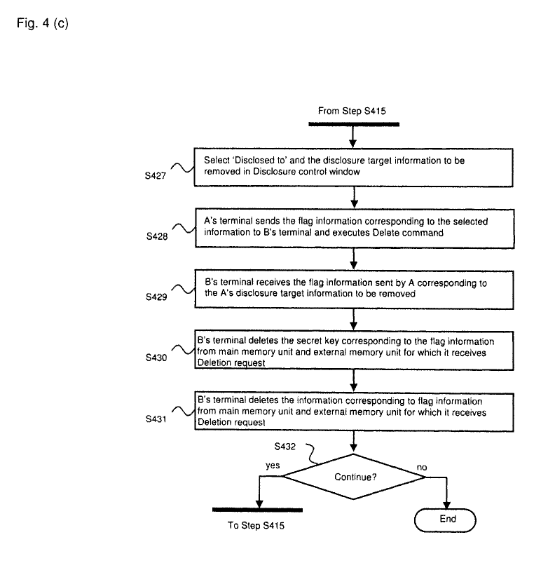

FIG. 4 shows an example of a flowchart for implementing the method of an embodiment of the present invention and the description given below is based on this flowchart.

The main memory unit 304 or the external memory unit 301 of user A's terminal 300 stores four pieces of disclosure target information X1a, X2a, X3a, X4a and four pieces of corresponding flag information Flg1a, Flg2a, Flg3a and Flg4a in the memory 315. Here, any type and amount of information can be used for the flag information to be associated with the disclosure target information. For example, the number that specifies each disclosure target information or the hash value of each disclosure target information can be set as a first flag information, and the identification tag that specifies the discloser can be set as second flag information. These two pieces of flag information may be associated with each disclosure target information and then sent. In another example of flag information, the disclosure target information needs not to be specified, but the keyword that may be used to narrow-down the disclosure target information may be used. Further, the flag information may also be the information indicating priority of whether to store or clear the disclosure target information sent to the terminal of a recipient of disclosed information in the subsequent steps, from the memory unit of a terminal of a recipient of disclosed information having restricted storage capacity.

Similarly, the names of the users who become disclosure destinations namely the user B, the user C, the user D, and the user E and associated identification tags IDb, IDc, IDd, and IDe which are required to uniquely identify each terminal on the network are stored as a disclosure destination database 316 on the main memory unit of user A's terminal 300. First of all, the arithmetic and logic unit 303 on the user A's terminal creates four secret keys 302 namely k1a, k2a, k3a, and k4a on the main memory unit 304 for encrypting the above mentioned 4 users' information. These also may be stored in the external memory unit 301. However, the above mentioned four disclosure target information X1a, X2a, X3a, and X4a and the associated corresponding flag information Flg1a, Flg2a, Flg3a, and Flg4a and above mentioned secret keys k1a, k2a, k3a, and k4a are loaded on the main memory unit 315 (Step S402).

Further, the arithmetic and logic unit 303 on the user A's terminal encrypts the above mentioned four users' information by using the above mentioned four secret keys respectively according to a procedure, which is defined in the application program 305 in an embodiment of the present invention on the main memory unit 304 and stores it on the main memory unit after creating Ek1a (X1a), Ek2a (X2a), Ek3a (X3a), and Ek4a (X4a) (Step S403). Here, for example, Ek1a (X1a) indicates the encrypted information in the calculation result, which is the information X1a encrypted by using the secret key k1a in the arithmetic and logic unit 303 as an encryption device. The encryption algorithm such as the DES (Data Encryption Standard), the triple DES, the AES (Advanced Encryption Standard) may be used here. Communication unit 306 on the user A's terminal sends the above mentioned four calculation results Ek1a(X1a), Ek2a(X2a), Ek3a(X3a), and Ek4a(X4a) and associated respective flag information, to the information distribution server 200 via the network 10. For example, the calculation result Ek1a (X1a) is sent to the server 200 along with the associated flag information Flg1a, which is associated with X1a at the above mentioned Step 401 (Step 404).

The transmission and reception part 201 of the server 200 receives the above mentioned four calculation results, which are sent to the server in the above mentioned second step, and associated to the corresponding above mentioned flag information. Further, the table creation part 202 of the server 200 stores the information received from the above mentioned user A's terminal to the memory unit 204, as data in a database (Step S405).

On the user A's terminal, the application program 305 of an embodiment of this invention displays a graphical user interface (hereinafter referred to as GUI) 311 on the display device 310 via the display control unit 309 as per the instructions received by the input devices such as keyboard 307 and a mouse 308. On this GUI 311, the disclosure control window 312 is displayed by the signal that is sent to the display device 310 via the display device 309 from the application program 305 of an embodiment of the present invention (Step S406).

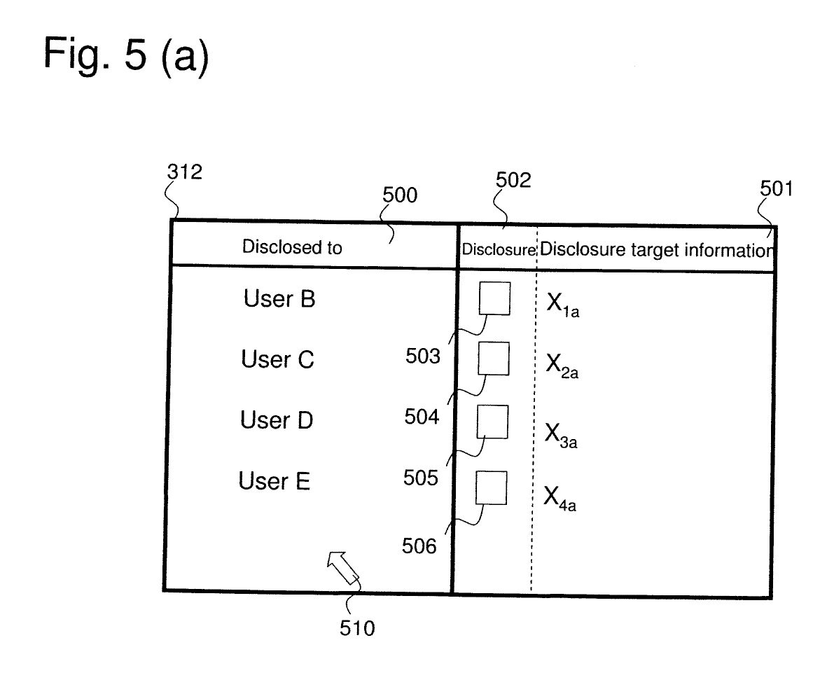

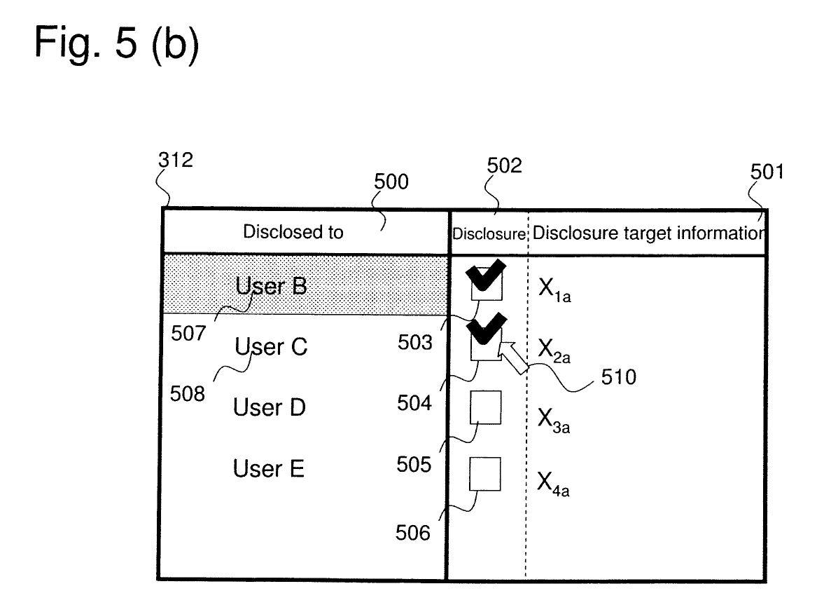

FIG. 5(a) shows an example of disclosure control window 312, which is displayed on the display device 310 of the user A's terminal 300. The disclosure control window 312 includes the column 500 showing the disclosure destination, the column 501 showing the disclosure target information, and the column 502 of the check boxes for the disclosure status display and the disclosure control. In the example shown in FIG. 3(a) to FIG. 5, the four user names i.e., User B, User C, User D, and User E are displayed as the disclosure destinations (in the column 500) and also the information X1a, X2a, X3a, and X4a are displayed as the disclosure target information (in the column 501). In addition, in the disclosure column 502, the check boxes 503, 504, 505, and 506 corresponding to the above mentioned four disclosure target information are displayed. For example, the first check box 503 is used for the disclosure status display and disclosure control of the disclosure target information X1a.

Next, in the user A's terminal 300, by the input received by the keyboard 307 and/or the mouse 308, the operating system moves the cursor 510 on the GUI 311, for example, when the user B is selected, disclosure of target information is controlled by the user A's terminal 300, for the user B's terminal 320. Further, from the status of FIG. 5(a), by the input by the mouse 308 etc. the cursor 510 is moved to the checkboxes 503 and 504 located at the left side of disclosure target information X1a and X2a. Here, when a mouse button is clicked, for example, a check mark is displayed on each of checkboxes 503 and 54 as shown in FIG. 5(b). According to an embodiment of the present invention, this operation indicates that the information X1a and X2a is to be disclosed from the user A's terminal 300 to the user B's terminal 320, with respect to the application software 305 (Step S407). The following is an explanation of the method of an embodiment of the present invention with reference to FIG. 4(b), in which disclosure of information X1a and X2a from the user A's terminal 300 to the user B's terminal 320, is taken as an example.

The information X1a and X2a to be disclosed by the user A's terminal to the user B's terminal through the GUI311 at the previous Step S407 in the user A's terminal, is indicated to the application program of an embodiment of the present invention. In the calculation device 303, the flag information Flg1a, which is assigned for searching X1a, is associated with the secret key k1a, which is created to encrypt the information X1a at Step S402, and the flag information Flg2a, which is assigned for searching X2a, is associated with the secret key k2a, which is created to encrypt the information X2a at Step S402, and are stored temporarily in the main memory unit 304. Further, after searching the identification tag IDb of the user B from the disclosure destination database 316, the communication part 306 sends two groups of information 12, i.e., a group of k1a and Flg1a and a group of K2a and Flg2a, which are stored temporarily, to the user B's terminal 320 through the disclosure control server 120 by using this identification tag IDb (Step S408). At Step S404, the flag information associated with each secret key may be any information that can uniquely specify the disclosure target information, among multiple flag information associated with the encrypted information sent to the information distribution server 200 by the user A's terminal. For example, at Step S404, the number that specifies respective disclosure target information may be set as first flag information, and the identification tag that uniquely specifies the discloser may be set as second flag information. When these two flag information are associated and sent to the information distribution server 200, the first and second flag information may be sent to the disclosure control server 120 by associating with each secret key respectively.

Further, in the user B's terminal 320, at Step S408, the information of two groups k1a and Flg1a, and k2a and Flg2a sent by the user A's terminal 300 to the user B's terminal through the disclosure control server 120, is received by the communicator 326. After it is stored in the main memory unit 324, if required, it is stored in the external memory unit 321 (Step S409).

Further, the application program 325 of an embodiment of the present invention stored in the main memory unit 324 of the user B's terminal 320 sends the flag information Flg1a and Flg1b sent from the user A's terminal at Step S408, to the server 200 through the communication part 326, and thus requests the database stored in the memory unit 204 of the server for searching the encrypted information associated with Flg1a and Flg1b respectively (Step S410). This search request may be executed at any time. For example, at the above mentioned Step S408, a request may be executed immediately after the user B's terminal 320 receives Flg1a and Flg1b. Or when in the user B's terminal, according to the signals from the keyboard 327 or the mouse 328, explicit operations for acquiring the information disclosed from the server are executed for the application program of an embodiment of the present invention, a search request may be executed for the information distribution server 200. Further, before Step S408, a search request may be executed after the user B's terminal 320 acquires any information from the information distribution server 200. However, in this case, the information acquired from the information distribution server 200 needs not to be encrypted until the secret key is received from the user A's terminal, hence this information cannot be used by the user B's terminal.

The search part 203 of the server 200 searches the database on the memory unit 204 and sends as the search result Ek1a(X1a) and Ek2a(X2a), which is the information associated with Flg1a and Flg1b, for which a search request is received from the user B's terminal 320 at Step S410, to the user B's terminal 320 through transmission and reception part 201 (Step S411).

Next, the communication part of the user B's terminal 320 receives Ek1a(X1a) and Ek2a(X2a), which are sent from the server 20 at the above mentioned S411, and stores them in the main memory unit. EK1a(X1a) and Ek2a(X2a) are respectively decrypted with the secret key K1a, which is obtained through the disclosure control server 120 from the above-mentioned user A's terminal, and the secret key k2a, which is obtained from the same above-mentioned user A's terminal (Step S412). X1a and X2a are stored in the main memory and after that application program 325 in an embodiment of the present invention displays X1a and X2a as information disclosed by the user A on the display window 332 as the information displayed and disclosed on the GUI 323 (Step S413). In the example shown in FIG. 3(b), information X1a and X2a disclosed from the user A's terminal 300 is displayed on the disclosure information display window 332 displayed on the GUI 331, which is displayed on the display unit 330 of the user B's terminal 320.

Further, in the above mentioned embodiment of the present invention, the communication part 306 of the user A's terminal 300 functions as a sending device that sends the encrypted information and secret key. Specifically, the communication part 306 sends the generated multiple encrypted information (Ek1a(X1a), Ek2a(X2a), etc.) to the information distribution server 200 in the status associated with respective flag information (Flg1a, Flg2a, etc.) and stores it in the memory unit 204 of the information distribution server 200. On the other hand, the secret keys (k1a, k2a) are generated for each disclosure information (X1a, Xa, etc.) in the arithmetic and logic unit 303 of the user A's terminal 300 and it is sent to the disclosure control server 120 by the communication part 306 in the status associated with respective flag information.

The user B's terminal 302 functions as a composite device and receives the encrypted information through the communication part 306 of the user A's terminal 300 and the transmission/reception part 201 of the information distribution server 120. Moreover, a secret key is received through the communication part 306 of the user A's terminal 300 and the transmission/reception part of the disclosure control server 120 (not shown in the drawings). As mentioned above, since a respective flag is associated with the secret key and encrypted information in an embodiment of the present invention, the secret key and encrypted information is sent to and managed in the separate servers, and since it is possible to send it to the user B through the respective servers, it is more secure. In addition to this, in an embodiment of the present invention encrypted information and the secret key may be sent from the user A to the user B without using a server.

Moreover, according to the method of an embodiment of the present invention, any information disclosed from the user A to the terminal of the user B can be canceled. For example, as shown in FIG. 5(b), the user A's terminal 300 has disclosed the information X1a and X2a to the user B's terminal by using the method of an embodiment of the present invention mentioned previously. By using the keyboard 307 and the mouse 308 of user A's terminal, the cursor 510 is moved on the GUI 311 displayed on display unit 319, and a button is pressed at the checkbox 504 corresponding to the disclosure target information X2. Thus, according to an embodiment of the present invention, a checkmark on the checkbox 504 mentioned above is removed according to the procedure defined in the application program of an embodiment of the present invention (Step S427). This is the operation of the disclosure cancellation of the disclosure target information X2a from the user A's terminal 300 to the user B's terminal 320. A Step to cancel the disclosure is explained below with reference to FIG. 4(c).

Here, at the above-mentioned Step S427, regarding the disclosure canceled information X2a from the user A's terminal to the user B's terminal through the GUI311, the communication part 306 sends the flag information Flg2a corresponding to X2a along with the command and flag information indicating a delete request to the user B's terminal 320 through the disclosure control server 120 according to the instructions of application program 305 according to an embodiment of the invention of the user A's terminal (Step S428). The flag information Flg2a, which is sent from user A's terminal along with the command and the flag information indicating a deletion request as mentioned above and received by the communication part 326 of the user B's terminal 320, is stored temporarily in the main memory unit 324, and then the arithmetic and logic device 323 searches Flg2a, which may be in the main memory unit 324 or in external memory unit 321, and deletes the secret key k2a corresponding to it (Step S430). Moreover, in the same way, in the decrypted status corresponding to this flag information Flg2a, it is stored in the main memory unit 324 or the external memory unit 321 of the user B's terminal 320, the user A's information X2a is searched ant it is deleted (Step S431). The above-mentioned Step S430 and S431 may be executed in the reverse order. Thus, in the user B's terminal, the user A's information is not available and the disclosure cancellation is completed.

At Steps S430 and S431, which is mentioned above, while deleting the user A's secret key k2a and disclosure target information X2a from the user B's terminal, there will be no problem if the flag information Flg2a, which is stored by receiving it from the disclosure control server 120 at Step S409, which is mentioned above, and the encrypted information Ek2a(X2a) stored by receiving it from the information distribution server 200 at Step S411, which is mentioned above, are deleted or not deleted from the memory unit of the user B's terminal. If the disclosure target information X2a is again disclosed from the user A's terminal without deleting this flag information and encrypted information X2a, (same as at Step 409, which is mentioned above), when the secret key k2a and its flag information Flg2a is received from the disclosure control server, Steps S410 and S411, which are mentioned above, where encrypted information is sent from the information distribution server 200, are omitted and yet it is possible to display the disclosure target information decrypted by the user B's terminal.

The information to be disclosed in an embodiment of the present invention is not limited to documents, photos, videos, secret keys, public keys, or individual information such as a name, an address, an e-mail address, an account information of various communication services, a password etc., but it may be any sorts of information that may be displayed by a website.

Until now in the description of the present invention, the method is used in which each piece of information is encrypted by using a separate secret key. However, each piece of information may be encrypted using a common secret key for multiple pieces of information. In such a case, the above-mentioned multiple pieces of information may be disclosed collectively at the discloser's terminal, by sending the above-mentioned common secret key and associated flag information to the recipient of the disclosed information via the disclosure control server 120.

As an example, referring back to FIG. 1, the user A′ terminal 300 has disclosed information X1a and X2a to the user B's terminal, and information X2a and X3a to the user C's terminal 340 by executing above-mentioned steps. In this way, a user's terminal can disclose any information to multiple users' terminals by using the methods of an embodiment of the present invention.

In an embodiment of the present invention, one way disclosure from user A's terminal 300 to user B's terminal 320 is described so far. However, at the same time the information can be disclosed from the user B's terminal 320 to the user A's terminal 300 via the information distribution server 200 or the disclosure control server 120 by using the methods of the above-mentioned steps. Moreover such mutual disclosure can be executed mutually between multiple users' terminals.

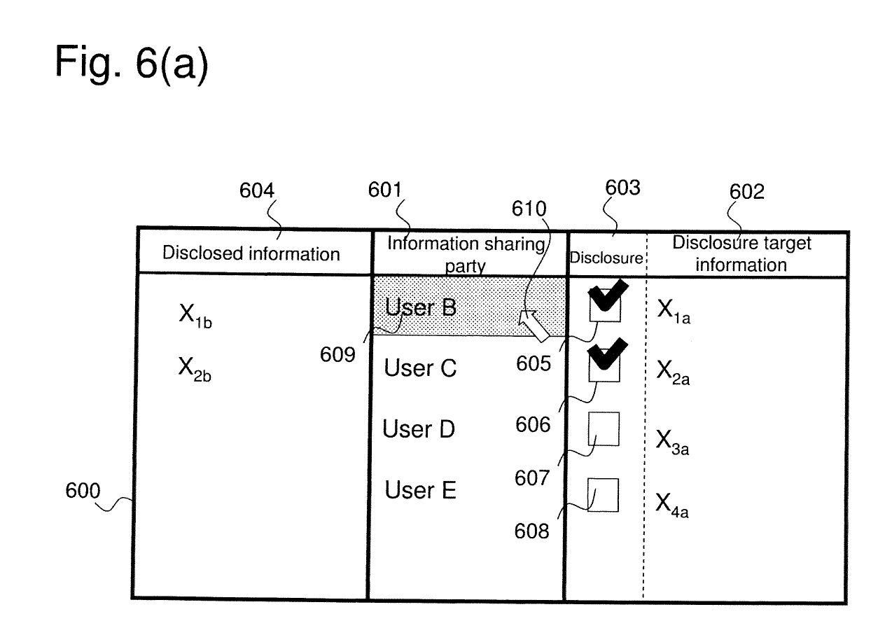

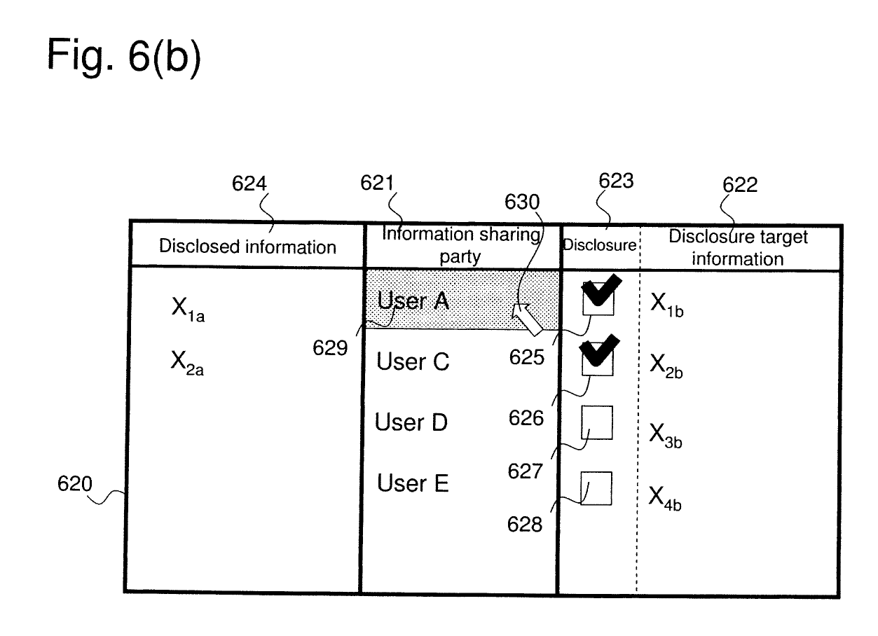

In FIG. 6, as an example of a display and control screen at the time of the mutual disclosure, the example of the information exchange window 600, which is displayed on the display device 310 of user A's terminal 300, is shown containing the functions of both; the window for the information disclosure and the window for displaying the disclosed information. The above-mentioned information exchange window 600 comprises a column 601 of the information exchange party, a column 602 of the disclosure target information, a column 603 of the disclosure control window, and a column 604 of the disclosed information. In this example, at Step S404, which is mentioned above, the user A's terminal 300 sends the encrypted disclosure target information by associating it with the flag information that includes an identification tag that identifies the user A's terminal to the information distribution server 200. The above-mentioned flag information may include the identification tag that specifies the discloser's terminal, not only for the information disclosure performed in an embodiment of the present invention from user A's terminal 300 to another terminal, but also for the information disclosure performed from another terminal to user A's terminal.

Referring to FIG. 6(a), here, based on the operations of the keyboard 307, the mouse 308, etc. of the user A's terminal 300, the cursor 610 is moved to indicate to the application program 305 stored in the main memory unit 304, and if the user B 609 of the information exchange party displayed in the information exchange window displayed in the display device 310 is selected, then X1a, X2a, X3a, and X4a that are to be disclosed are displayed, and the disclosure status to user B's terminal of disclosure information is displayed in the disclosure control column 603 by using a check mark. In the example in FIG. 6(a), it is shown that the user A's terminal 300 discloses the information X1a and X2a to the user B's terminal, by adding a check mark in the check boxes 605 and 606 corresponding to the disclosure target information X1a and X2a respectively. Similarly, in the window 600, X1b and X2b are displayed in the disclosed information column as the information disclosed to the user A by the user B in the reverse direction. The user B's terminal 320 not displayed here discloses the information related to the user A by the above mentioned method of an embodiment of the present invention, simultaneously on the GUI similar to the GUI 600.

In this state, regarding for the disclosure control, the disclosure status of any disclosure target information for the user B's terminal 320 can be changed by selecting any check box displayed in the disclosure control column with the help of the cursor 610 on the display device. For example, in the display device 310 of the user A's terminal 300, in the status shown in FIG. 6(a), when the check box 607 is selected (Step S407) by moving the cursor 600 to the check box 607 corresponding to the disclosure target information X3a, and by clicking the mouse button, a check mark is added and displayed in the check box 607. At the same time, the user A's terminal 300 sends the secret key k3a corresponding to the disclosure information X3a to the user B's terminal 320 through the disclosure control server 120 (Step S408). The user B's terminal 320 acquires the encrypted Ek3a(X3a) from the information distribution server 200, and after it is decrypted by the above-mentioned secret key k3a(Step S412), the information X3a disclosed by the user A's terminal 300 to the user B's terminal 320 is displayed in its display device (Step S413).

For example, in the display device 310 of the user A's terminal 300, in the status shown in FIG. 6(a), when the check box 605 is selected by moving the cursor 610 to the check box 605 corresponding to the disclosure target the information X1a, and by clicking the mouse button, the check mark in check box 605 is cleared (Step S427). At the same time, the user A's terminal 300 sends a request to user B's terminal 320 to clear the secret key k1a and the disclosure target information X1a corresponding to the disclosure information X1a(Step S428). The application software 325 of the current invention of the user B's terminal clears the above-mentioned secret key k1a and the disclosure target information X1a from the main memory unit and the external memory unit (Step S430 and Step S431). Thus, the user B can not decrypt the encrypted information Ek1a(X1a) and the disclosure target information X1a of the user A can not be displayed on the display device of the user A's terminal.

In this state, according to an embodiment of the present invention, the information X1b, X2b, X3b, and X4b stored in the user B's terminal 320 can be disclosed to the user A's terminal by executing each step mentioned above. In this case, the secret keys k1b, k2b, k3b, and k4b corresponding to the respective information, and the flag information Flg1b, Flg2b, Flg3b, and Flg4b corresponding to respective information is used.

The example shown in FIG. 6(b) is the status where the above-mentioned mutual disclosure window is displayed in the GUI 332 displayed in the display unit 330 of the user B's terminal. In the example shown in FIG. 6(b), as a result of selecting the user A 629 as the information exchange partner, in the disclosure target information column 622, the information disclosed to the user A's terminal by the user B's terminal is displayed with a checkmark that is displayed on the disclosure control column 623, and in the disclosed information column 624, the information disclosed from the user A's terminal by the user B's terminal is displayed. In the example shown in FIG. 6, the user A discloses the information X1a and X2a to the user B and the user B discloses the information X1b and X2b to the user A respectively. FIG. 6(a) shows the status of the user A's terminal and FIG. 6(b) shows the same status of the user B's terminal. In this status, the user A and the user B can disclose the new information to a partner and cancel the disclosure of disclosed information with the help of the above mentioned methods by selecting the checkbox of the disclosure control column 603 or the disclosure control column 623 respectively.

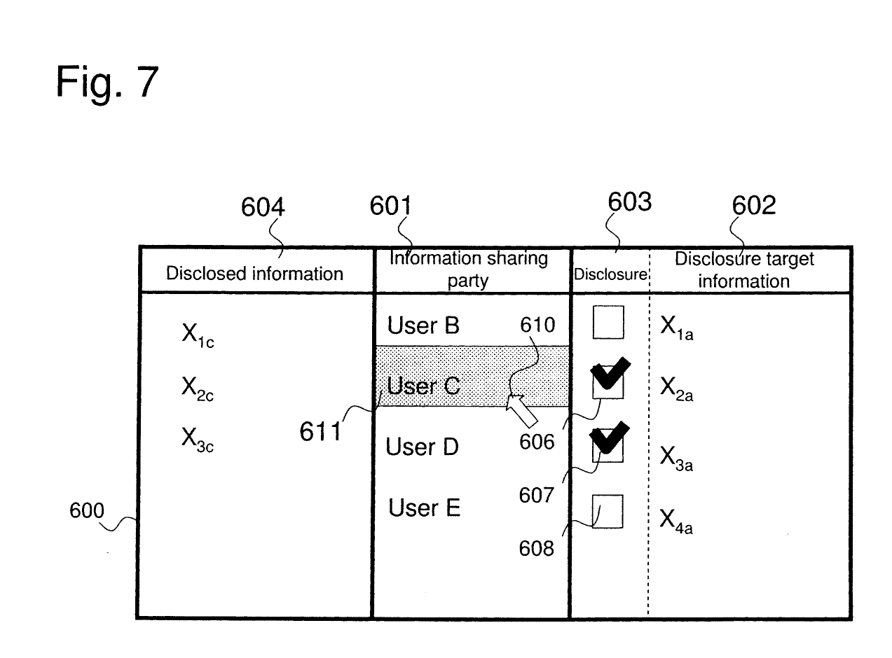

The explanation so far is the mutual disclosure of information between two terminals of the user A and the user B respectively. However, it can be the mutual disclosure between any numbers of terminals. The example shown in FIG. 7 is the status where the user C 611 is selected as a new information exchange partner in the mutual disclosure window 600 displayed on the GUI 311 of the display Unit 310 of the user A's terminal. In this state, the user A's terminal 300 discloses the information X2a and X3a to the user C's terminal 340 and the user C's terminal 340 discloses the information X1c, X2c, and X3c to the user A's terminal 300. Even in this state, the user A can display and control disclosure and non-disclosure information with different information exchange partners by selecting any information exchange partner.

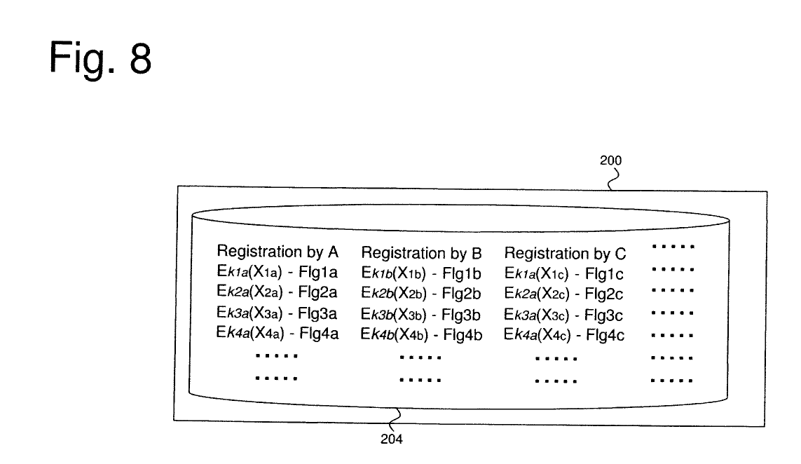

In the mutual disclosure between multiple terminals, the registered and encrypted information from each terminal and the flag information associated to each terminal shown in FIG. 8 is registered in the information distribution terminal 200 and regarding the specific flag information from a recipient of the disclosed information, any encrypted information according to a search request is sent to the terminal of the recipient of the disclosed information.

In the case, where the information is disclosed mutually by the multiple terminals, the disclosure target information of a terminal associated with the flag information and similarly the information disclosed from another terminal associated with flag information is stored in the memory unit of each terminal. In this case, each search device can search the information associated with specific flag information from the disclosure target information and the disclosed information of that terminal and can display that information. For example, in the user A's terminal shown in FIG. 6(a) and FIG. 7, the disclosure target information X1a, X2a, X3a, and X4a of the user A, the information X1b, X2b disclosed by the user B and the information X1c, X2c, and X3c disclosed by the user C is associated with respective flag information and then stored in the memory unit of the user A's terminal. When one of the flag information is the keyword for a search, the arithmetic and logic unit 303 according to the instructions of application program 305 of an embodiment of the present invention stored the main memory unit 304 of the user A's terminal can display the information desired by the user A on the mutual disclosure window 600 on the display unit 310 by searching the information associated with the keyword input by using the keyboard 307 from the above-mentioned information.

In an embodiment of the present invention, it is possible to manage and send the disclosure target information and a secret key deciding the disclosure relation to the terminal of the recipient of disclosed information, separately. If this characteristic is used, a backup of information in a terminal is possible. For example, referring to FIG. 1, suppose that all the information stored in the main memory unit 304 and the external memory unit 301 of the user A's terminal, disappears for some reason. In the method of an embodiment of the present invention, if the information for identifying the user A's terminal on a network, is included in the flag information of encrypted information stored in the information distribution server 200, the information distribution server 200 can send encrypted information Ek1a(X1a), Ek2a(X2a), Ek3a(X3a), and Ek4a(X4a) to the user A's terminal 300 by using this flag information. Further, since the secret key k1a and k2a, and the secret key k2a and k3a are associated with respective flag information and then stored in the user B's terminal 320 and the user C's terminal 340, the user B's and the user C's terminal can send the secret key k1a, k2a, and k3a to the user A's terminal 300 through the disclosure control server 120 by using this flag information. Thus, the user A's terminal can receive the encrypted information from the information distribution server 200 and a secret key from the disclosure control server 120 respectively, and can restore the disclosure target information X1a, X2a, and X3a.

However, in this case, with reference to FIG. 1, the disclosure target information X4a and the secret key k4a in the user A's terminal 300 is not completely disclosed to another terminal. Consequently, when the secret key k4a stored in the user A's terminal 300 disappears, it cannot be restored in any way. Even if the encrypted information Ek4a(X4a) is stored in the information distribution server 200 as shown in FIG. 1 and is returned to the user A's terminal, it is not possible to restore the disclosure target information X4a in the user A's terminal 300. To resolve this problem, the user A's terminal 300 stores the secret key k4a corresponding to the disclosure target information X4a, which has not been disclosed to anybody, either in the disclosure control server or in the terminal of another authentic user. When the information of the user A's terminal disappears, the disclosure target information X4a can be received by accepting this secret key. Thus according to an embodiment of this invention, even though the required backup operation is not executed explicitly beforehand using a conventional method, when the disclosure target information of the user A's terminal disappears, it can be restored.

Further, according to an embodiment of the present invention, the disclosure target information, and the secret key, which determines a disclosure relationship, can be controlled independently. The authority that executes disclosure control can be transferred to another terminal by maintaining the disclosure relationship or it can be shared with another terminal. For example, in the status shown in FIG. 1, the secret keys k2a and k3a , which determine the disclosure relationship of information, is sent from the user A's terminal 300 to the user C's terminal 340 through the disclosure control server 120. In other words, after k2a and k3a are sent to the user C's terminal, these are deleted from the user A's terminal. Because of this, the disclosure authority of information X2a and X3a is said to be shifted to the user C's terminal. However, before and after the shifting of disclosure authority, the disclosure status does not change, i.e. X2a remains disclosed to the user B's terminal 320. Thus, the authority for controlling the disclosure by maintaining the disclosure relationship can be shifted for each disclosure target, from the user A's terminal 300 to the user C's terminal 304. Similarly, by sharing the secret key and its controlling authority on various terminals, the disclosing rights can be shared.

By shifting and sharing the secret key from the discloser's terminal to another terminal, the authority to control disclosure of each disclosure target information can be shifted or shared. Similarly, by shifting or sharing the secret key to another terminal from the terminal of the recipient of the disclosed information, which has received a secret key; it is possible to control re-disclosure of the received information to other terminals.

Regarding with the backup, which is previously mentioned, or shifting and sharing of the disclosing rights, a feature of an embodiment of the present invention is used where the disclosure target information and its disclosure status can be controlled independently by using the secret key of respective disclosure target information. Due to this feature, an embodiment of the present invention has the following advantages.

The first advantage is that the disclosure target information and the disclosure status can be changed independently. In the conventional method, when the information X2a is to be disclosed from the user A's terminal to the user B's and the user C's terminals, the user A's terminal sends duplicate X2a to the user B's and the user C's terminals. After the user B's and the user C's terminals receive this duplicated X2a, it is stored in respective memory units. Further, according to the indication from the input devices of the user B's and the user C's terminals, duplicated X2a, which is stored in the respective memory units of the terminals, is displayed in the display device. According to this conventional method, when the information X2a is updated to X2a′, in the user A's terminal, it is necessary for the user A to execute explicit operations for sending duplicated X2a′, to the user B's and the user C's terminal. In other words, in this conventional method, for each information disclosure, the discloser has to send the information to the terminal of the recipient of the disclosed information after explicitly specifying the disclosure target information as well as the disclosure destination.

On the other hand, the user A, who is the discloser, can independently change the targeted information and corresponding discloser status (disclosure destination) by using the methods of an embodiment of the present invention. For example, on the user A's terminal 300, even if the information to be disclosed i.e. X2a′ is updated to X2a′, the corresponding secret key k2a′ and the flag information Flg2a′ are not changed. Consequently, the user A's terminal 300 sends the information Ek2a(X2a′) encrypted by using the secret key k2a′ to the information distribution server 200. Information distribution server 200 retains this Ek2a(X2a′) associated with the flag information Flg2a′ in the database of its memory unit 204. Thus even though the user A does not send explicitly the updated X2a′, to the user B and the user C, the updated information is available on the user B's terminal 320 and the user C's terminal 340 without changing their disclosure status. On the other hand, when the information to be disclosed i.e. X2a′ is not changed on the user A's terminal and the information is disclosed both on the user B's terminal and the user C's terminal, and while changing the disclosure status such as the information is disclosed also to the user D's terminal, the discloser status of the information X2a′ can be changed just by sending the secret key k2a′ and the flag information Flg2a′ to the user D's terminal via the disclosure control server, without making any changes in the information X2a′ that is to be disclosed, the secret key k2a′ and the flag information Flg2a. In this way, the methods of an embodiment of the present invention provide the feature that the user A, who is the discloser, can change independently the information to be disclosed and its disclosure relation with other users' terminals.

The second advantage is that the information disclosure control is easier compared to the conventional methods. In the conventional methods, in the case where specific information is disclosed via a server to only specific users, the information distribution server first authenticates the user by using user name, password, etc., then the discloser sends the information to be disclosed only to the predefined users. In the conventional methods, the service provider should have in advance the usernames and passwords of all users stored in a database and it is necessary to authenticate the user requesting information disclosure. The problem is that a control method to set the ‘disclosure destination’ for each piece of information and the GUI required by the discloser to control the information on terminals has become complicated. In response, the method of an embodiment of the present invention provides the feature that, if there is a method where the discloser can send the secret key or the flag information to the recipient of the disclosed information, the management of the user name and the password which is necessary in the conventional methods can be avoided, and thus it simplifies the disclosure control or corresponding GUI on terminals. Thus information disclosure has become more flexible as compared to the conventional methods.

The third advantage is that it is easier to maintain the secrecy. In the conventional methods, the information to be disclosed is stored on the information distribution server in the form of plain text, and it is sent to the terminal of a recipient of the disclosed information in response to their request. Even in the conventional method, the information is encrypted by using the methods such as SSL (Secure Socket Layer) on a network communication pathway, with the purpose of non-disclosure. However, it is stored in the form of plain text on the information distribution server. Thus, the problem is, in the case where access to the server itself is opened to the public for any reason, all the information stored in the information disclosure server is accessible to anyone. Generally, the method of authentication of the recipient of disclosed information is not sufficient and there is a risk of disclosure of information to a person other than the one specified by the discloser. However, according to the method of an embodiment of the present invention, all information to be disclosed is stored in the information distribution server by encrypting the information using corresponding secret keys. Thus even in the case where the information stored in the server is released to the public, the server secrecy remains intact unless the secret key required to decrypt the information is obtained. In the method of the present invention, since these secret keys are scattered on a number of terminals, it is difficult to actually obtain all these keys and thus it is easier to maintain the secrecy of the information stored on the information distribution server.

Even though a terminal with a low capacity memory unit is used, it can be used efficiently for the data exchange. This is considered as the fourth advantage of an embodiment of the present invention. As per the conventional methods, if the terminal of a recipient of disclosed information receives the information disclosed by the discloser, it is necessary to save the disclosed information in the memory unit. Therefore, if the memory unit capacity of the terminal is low, a large quantity of the disclosed information can not be retained. In another conventional method, as per requirement, the recipient of the disclosed information obtains the information to be disclosed from the information distribution server, and the disclosed information need not be saved in the memory unit of the terminal of the recipient of the disclosed information. Moreover, as mentioned previously, a low capacity memory unit of the terminal can be used here. However, in this case, the disclosed information can not be used without a network connection. In the method of the present invention, the secret key of the disclosed information is saved in the memory unit of the terminal of the recipient of disclosed information. As mentioned in the first advantage, in the method of an embodiment of the present invention, the secret keys defining the disclosure status are separated from the information to be disclosed. Therefore, the information to be disclosed may exist in the memory unit of the terminal of the recipient of the disclosed information, the information distribution server, and the terminal of the discloser or the terminal of a third person. Therefore, even though the recipient of the disclosed information is not connected to the network, only the information to be used is stored in the memory unit of the terminal of the recipient of disclosed information, and the disclosed information can be used flexibly by acquiring other information whenever required from the information distribution server. In other words, in the method of an embodiment of the present invention, the terminal of the recipient of disclosed information provides the feature that the information to be disclosed can be managed flexibly as per the capacity of the memory unit and the nature of the information to be disclosed.

The fifth advantage is that the backup of the information to be disclosed can be performed easily. In the conventional methods, the disclosed information is saved in the memory unit of the terminal of the recipient of the disclosed information, in addition to the information that exists on an information distribution server or terminal of the discloser. Therefore, the information in the memory unit of the terminal of the recipient of disclosed information may be lost due to some reason. To avoid this, in most cases the recipient of disclosed information makes the backup of the data stored in the memory unit of a terminal in another memory unit. However, in the method of an embodiment of this invention, even though the data stored in the memory unit of a terminal of the recipient of disclosed information is lost due to some reason, the disclosed information can be restored by obtaining the secret key and the flag information corresponding to the information to be disclosed from the terminal of the discloser. In other words, it provides the feature that the lost information can be restored even though the recipient of disclosed information does not make the backup of a memory unit of the terminal.

The sixth advantage is that the amount of duplicated information on the entire network can be reduced. In the conventional methods, while disclosing the information to several recipients of disclosed information, on the terminal of the discloser, the information is copied for only the number of recipients of the disclosed information, that information is sent to the terminal of all recipients of the disclosed information, and the copied information is stored in the memory units of terminals of all the recipients of the disclosed information. Therefore, in the entire network, the same information is copied several times and it is stored repeatedly on several terminals. However, in the method of an embodiment of the present invention, the secret key corresponding to the disclosed information is to be saved in the terminal of the recipient of the disclosed information. Accordingly, except for the required information when disconnected from the network, the copy of the disclosed information need not be stored in the terminal of the recipient of the disclosed information. As a result, as compared to the conventional method, it provides a feature that the amount of the duplicated information on the entire network can be reduced.

From another viewpoint, according to an embodiment of the present invention, information can be managed by maintaining the consistency of information easily even when information and the destination of disclosure of that information has changed. Moreover, disclosure management of information becomes easy and an unwanted flow of information can be prevented.

What is claimed is:

1. An information exchange device comprising:
a storage device which stores information items for disclosure related to a user who discloses the information items;
an encryption device which generates encrypted information items by encrypting each item of information for disclosure using a plurality of prepared secret keys which correspond to each of the information items for disclosure;
a transmitting device which transmits the encrypted information items and the plurality of prepared secret keys; and
a decryption device which receives an encrypted information item which is arbitrarily selected from the encrypted information items, receives a secret key related to the selected encrypted information item from among the plurality of prepared secret keys, and decrypts the selected encrypted information item using the secret key.

2. The information exchange device according to claim 1, wherein the storage device stores flag information so that the flag information is correlated with each of the information items for disclosure, the encryption device correlates each of the encrypted information items with corresponding flag information of the information items for disclosure and stores the correlated encrypted information items in the storage device, the transmitting device transmits each encrypted information item which is correlated with corresponding flag information, and the decryption device receives the encrypted information items as a result of a search using flag information as a search key, the flag information being related to the encrypted information item which is arbitrarily selected from the encrypted information items and wherein the decryption device decrypts the encrypted information item.

3. The information exchange device according to claim 2, wherein the transmitting device transmits the flag information of each of the information items for disclosure and the encrypted information items generated from each information item for disclosure to a first server, the first server storing the flag information and the encrypted information item, with the flag information being correlated with the encrypted information item, and transmits the flag information of each of the information items for disclosure and the plurality of prepared secret keys which correspond to each of the information items for disclosure to a second server, the second server storing the flag information and the plurality of prepared secret keys, the flag information being correlated with the plurality of prepared secret keys, and the decryption device receives an encrypted information item which is arbitrarily selected from the encrypted information items from the first server and receives a secret key related to the selected encrypted information item from among the plurality of secret keys from the second server.

4. The information exchange device according to claim 1, wherein the information exchange device is formed so that the information items for disclosure and the prepared secret keys related to the information items for disclosure are independently set, changed, and erased.

5. The information exchange device according to claim 1, wherein at least one piece of the information items for disclosure includes a plurality of sub disclosure information items.

6. The information exchange device according to claim 2, further comprising:
an input device in which after the information items for disclosure are displayed, disclosure information which is selected from among the plurality of information items for disclosure as information to be disclosed by the user who discloses the disclosure information to another user is specified;
wherein: when an input which specifies the disclosure information is input to the input device, the encrypted information item related to the disclosure information is correlated with flag information related to the disclosure information and transmitted by the transmitting device.

7. The information exchange device according to claim 6, wherein the input device includes a non-disclosure input function which changes the status of the disclosure information to the non-disclosed state, and when an input which specifies the disclosure information is input to the input device, an erase command is generated which erases one or more of the disclosure information, the encrypted information item related to the disclosure information or a prepared secret key which is used to encrypt the disclosure information and the erase command which is generated are correlated with the flag information of the disclosure information and transmitted by the transmitting device.

8. An information exchange device comprising:
a storage device which stores information items for disclosure related to a user who discloses the information items for disclosure and also stores flag information of each of the information items for disclosure, the information items for disclosure and the flag information being correlated and stored in the storage device;
an encryption device which generates encrypted information items by encrypting each of the information items for disclosure using a plurality of prepared secret keys which correspond to each of the information items for disclosure and the encrypted information items and the flag information of information items for disclosure corresponding to the encrypted information items being correlated and stored in the storage device; and
a transmitting device which transmits the encrypted information items with each of the encrypted information items correlated with the flag information.

9. The information exchange device according to claim 8, further comprising:
a decryption device which receives encrypted information items as a result of a search using flag information as a search key, the flag information being related to an encrypted information item which is arbitrarily selected from the encrypted information items, receives a secret key related to the selected encrypted information item, and decrypts the selected encrypted information item using the secret key.

10. The information exchange device according to claim 9, wherein the transmitting device transmits the flag information of each of the information items for disclosure and the encrypted information items which is generated from each of the information items for disclosure to a first server, the first server storing the flag information and the encrypted information items, the flag information being correlated with the encrypted information items, and transmits the flag information of each of the information items for disclosure and the plurality of prepared secret keys which correspond to each of the information items for disclosure to a second server, the second server storing the flag information and the plurality of prepared secret keys, the flag information being correlated with the plurality of prepared secret keys, and the decryption device receives an encrypted information item which is arbitrarily selected from the plurality of encrypted information items from the first server and receives a secret key related to the selected encrypted information item from among the plurality of secret keys from the second server.

11. The information exchange device according to claim 8, wherein the information exchange device is formed so that the information item for disclosure and the prepared secret key related to the information item for disclosure are independently set, changed, and erased.

12. The information exchange device according to claim 8, wherein at least one piece of the information items for disclosure includes a plurality of sub disclosure information items.

13. The information exchange device according to claim 8, further comprising:
an input device in which after an information item for disclosure is displayed, disclosure information which is selected from among the information items for disclosure as information to be disclosed by the user who discloses the disclosure information to another user is specified;
wherein: when an input which specifies the disclosure information is input to the input device, the encrypted information item related to the disclosure information is correlated with flag information related to the disclosure information and transmitted by the transmitting device.

14. The information exchange device according to claim 13, wherein the input device includes a non-disclosure input function which changes the status of the disclosure information to the non-disclosed state, and when an input which specifies the disclosure information is input to the input device, an erase command is generated which erases one or more of the disclosure information, encrypted information item related to the disclosure information or a secret key which is used to encrypt the disclosure information and the erase command which is generated are correlated with the flag information of the disclosure information and transmitted by the transmitting device.

15. An operation method of an information exchange device comprising:
reading information items for disclosure related to a user who discloses the information for disclosure which is stored in a storage device;
generating encrypted information items by encrypting each of the information items for disclosure using a plurality of prepared secret keys which correspond to each of the information items for disclosure;
transmitting the encrypted information items and the plurality of prepared secret keys; and
receiving an encrypted information item which is arbitrarily selected from the encrypted information items and receiving a prepared secret key related to the selected encrypted information items from among the plurality of prepared secret keys and decrypting the selected encrypted information item using the secret key.

16. The operation method of an information exchange device according to claim 15, further comprising:
storing flag information of each of the information items for disclosure in the storage device, the flag information being correlated with the information items for disclosure;
storing each of the encrypted information items and corresponding flag information of information for disclosure in the storage device, the flag information being correlated with the encrypted information items;
transmitting the encrypted information items, the encrypted information items being correlated with each of the flag information; and
decrypting the encrypted information item as a result of a search using flag information as a search key, the flag information being related to the encrypted information item which is arbitrarily selected from the encrypted information items.

17. The operation method of an information exchange device according to claim 16, wherein flag information of the information items for disclosure is correlated with the encrypted information items which is generated from the information items for disclosure and then transmitted to a first server, the first server storing the plurality of information for disclosure, and the flag information of the information items for disclosure is correlated with the prepared plurality of secret keys corresponding to each of the information items for disclosure and then transmitted to a second server, the second server storing the flag information and the plurality of prepared secret keys, the flag information being correlated with the plurality of prepared secret keys, and encrypted information item arbitrarily selected from among the encrypted information items is received from the first server and a secret key related to the selected encrypted information item among the plurality of secret keys is received from the second server.

18. The operation method of an information exchange device according to claim 15, wherein the information exchange device is formed so that the information item for disclosure and the prepared secret key related to the information item for disclosure are independently set, changed, and erased.

19. The operation method of an information exchange device according to claim 15, wherein at least one piece of the information items for disclosure includes a plurality of sub disclosure information items.

20. The operation method of an information exchange device according to claim 16, wherein the information exchange device further comprises:
an input device in which after the information item for disclosure is displayed, disclosure information which is selected from among the information items for disclosure as information to be disclosed by the user who discloses the disclosure information to another user is specified;
wherein: when an input which specifies the disclosure information is input to the input device, the encrypted information item related to the disclosure information is correlated with flag information related to the disclosure information and transmitted by the transmitting device.
